(19) United States
(12) Patent Application Publication
(10) Pub. No.: US 2009/0010021 A1
(43) Pub. Date: Jan. 8, 2009

(54) RECREATIONAL APPARATUS AND METHOD OF MAKING THE SAME

(76) Inventors: Jeffrey T. Smith, Washington, MI (US); Michael Waraniak, Fenton, MI (US); Michael C. Blicher, Clarkston, MI (US); Mukund P. Gupte, Troy, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 12/167,785

(22) Filed: Jul. 3, 2008

Related U.S. Application Data
(60) Provisional application No. 60/948,230, filed on Jul. 6, 2007.

(51) Int. Cl. B60Q 1/26; C09J 163/00

(52) U.S. Cl. 362/565; 156/330

(57) ABSTRACT

A recreational apparatus includes a base layer forming one opposed side of the apparatus. A core layer is established on the base layer, the core layer having a fiber optic sheet assembly integration pocket defined therein. A fiber optic sheet is established in the integration pocket. The fiber optic sheet has a plurality of protrusions therethrough. An illumination source and a power supply are each operatively connected to the fiber optic sheet. A cover layer is established on the fiber optic sheet and the core layer.

### CROSS-REFERENCE TO RELATED APPLICATIONS

This application claims the benefit of U.S. Provisional Patent Application Ser. No. 60/948,230 filed Jul. 6, 2007, which is incorporated herein by reference in its entirety.

### BACKGROUND

The present disclosure relates generally to a recreational apparatus, and to a method of making the same.

Many recreational devices and accessories are currently available. Such devices range from human-powered devices to mechanically-powered devices to hybrid human/mechanically powered devices. Graphics and/or lights have been added to some recreational devices, generally in an attempt to make the device more aesthetically pleasing.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a top perspective view of an embodiment of a core layer having a fiber optic sheet assembly integration pocket and a housing groove defined therein;

FIG. 2 is an alternate top perspective view of an embodiment of a core layer having two fiber optic sheet assembly integration pockets and a housing groove defined therein;

FIG. 3 is a top perspective view of an embodiment of tooling used to form the fiber optic sheet;

FIG. 4 is a top perspective view of the tooling of FIG. 3 having the fiber optic sheet established therein;

FIG. 5A is a top view of an embodiment of the fiber optic sheet;

FIG. 5B is a cross-sectional view along line 5B-5B of FIG. 5A;

FIG. 6A is a top view of another embodiment of the fiber optic sheet;

FIG. 6B is a cross-sectional view along line 6B-6B of FIG. 6A;

FIG. 7A is a top perspective view of one embodiment of a housing configured at one area to receive ferrules of a fiber optic sheet;

FIG. 7B is a top perspective view of another embodiment of a housing configured at two areas to receive ferrules of fiber optic sheets;

FIG. 8 is a top view of an embodiment of the cover layer of the recreational apparatus having a portion routed out;

FIG. 9A is a top, cut-away perspective view of an embodiment of the recreational apparatus with the cover layer and housing routed out;

FIG. 9B is a top, cut-away perspective view of an embodiment of the recreational apparatus of FIG. 9A with a power supply and illumination supply being implemented into the routed out housing;

FIG. 9C is a top, cut-away view of the recreational apparatus of FIG. 9B with the power supply and illumination supply integrated into the routed out housing;

FIG. 9D is a top, cut-away view of the recreational apparatus of FIG. 9C with a stomp pad removably secured to cover the integrated power supply and illumination supply;

FIG. 10 is a top view of an embodiment of the recreational apparatus;

FIG. 11 is a top perspective view of each layer of one embodiment of the recreational apparatus;

FIG. 12 is a photograph of a portion of an embodiment of the recreational apparatus with the fiber optic sheet illuminated and the stomp pad removed; and

FIGS. 13A and 13B are photographs of a portion of an embodiment of the recreational device with the fiber optic sheet not illuminated and illuminated, respectively.

### DETAILED DESCRIPTION

Embodiments of the recreational apparatus disclosed herein advantageously include personalized and/or customized graphics which may be illuminated via elements that advantageously do not interfere with the exterior design, feel or function of the apparatus. In some instances, the illuminating elements disclosed herein advantageously enhance light transmission throughout the apparatus, thereby enabling the lit apparatus to exhibit a fiery glow.

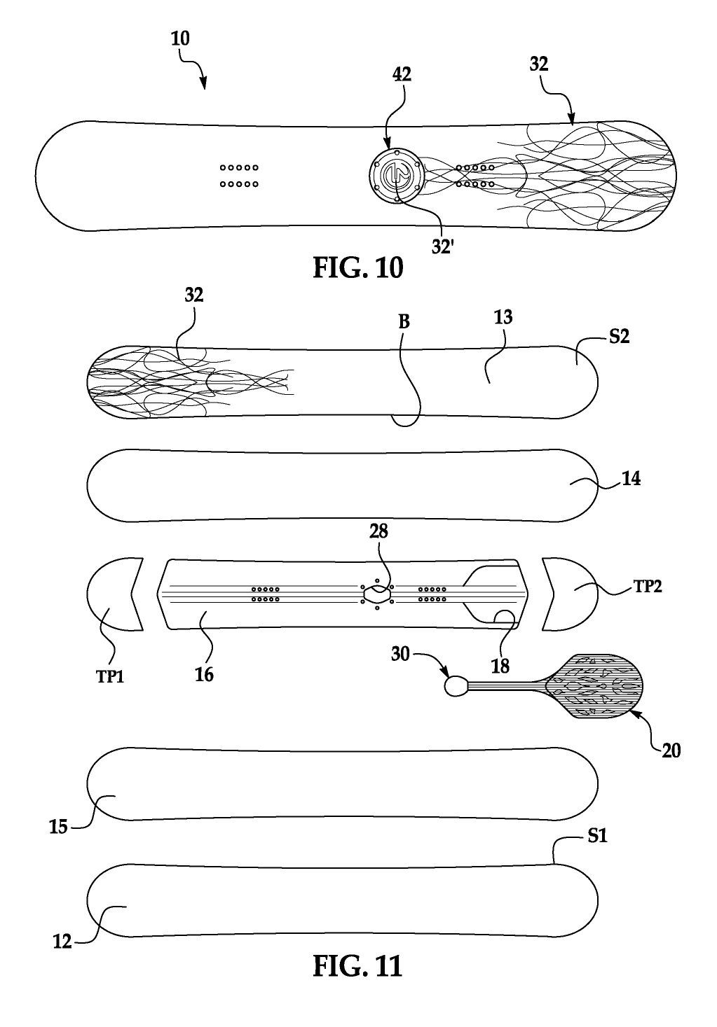

In one embodiment, apparatus 10 (a non-limiting example of which is shown in its entirety in FIG. 10) is a snowboard or a skateboard. When the apparatus 10 is a skateboard, it also includes wheels operatively connected thereto. In other embodiments, the apparatus 10 is selected from snowskis, waterskis, wakeboards, street luges, fenders of motorcycles, cowling of snowmobiles, fenders and/or seating area of mountain bikes, and fenders and/or seating area of motorcross bikes (BMX).

Referring first to FIG. 11, the recreational apparatus 10 includes a base layer 12 forming one opposed side S1 of the apparatus 10, and a top layer 13 forming the other opposed side S2 of the apparatus 10. Generally, the base layer 12 is formed of a P-tex material (an extruded high molecular weight, high density, porous polyethylene). This material is particularly suitable for a snowboard. Examples of other suitable materials for the base layer 12 include clear polymeric materials (e.g., polycarbonates, PLEXIGLAS®, or the like). The base layer 12 material may be transparent, opaque, printed on, or die cut with different colors. It is to be understood that the shape, size and thickness of the base layer 12 will depend, at least in part, on the apparatus 10 to be formed. Furthermore, in embodiments in which the apparatus 10 is a skateboard, the base layer 12 may include truck risers and other underbody skateboard elements.

The top layer 13 may be formed of a polymeric material (e.g., a vinyl material) that is capable of having graphics 32 printed thereon. For example, top layer 13 may be a clear sheet that any graphic may be dye sublimated to. The material on the back B of top layer 13 may be a fiber that is impregnated therein. Such a fiber may advantageously allow epoxy, which adheres all of the layers together, to adhere better.

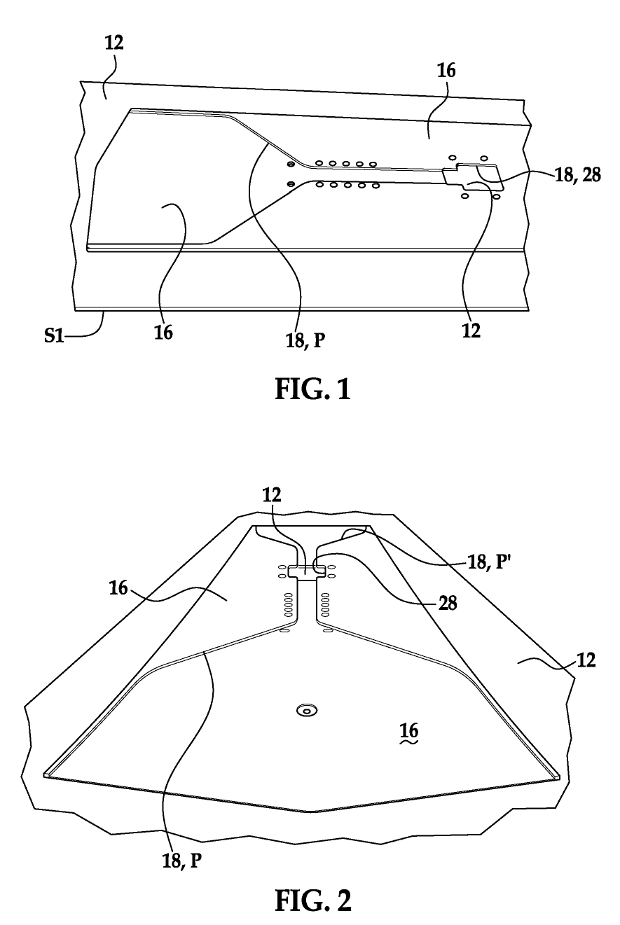

A core layer 16 (also see FIGS. 1 and 2) is established on the base layer 12 and includes at least one fiber optic sheet assembly integration pocket 18 defined therein. The core layer 16 generally also includes a groove 28 configured to receive a housing 30.

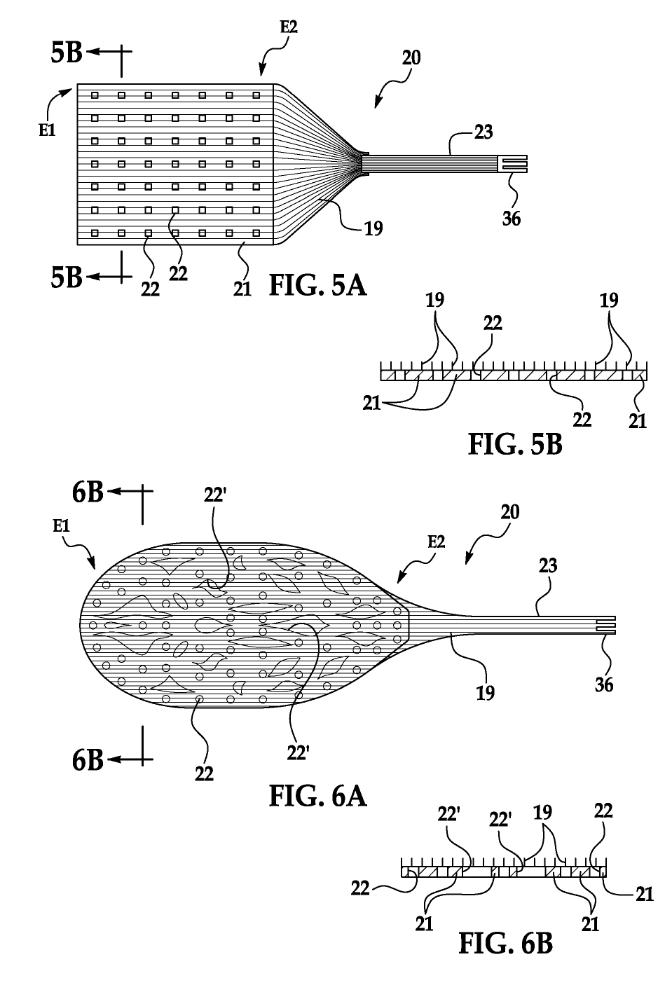

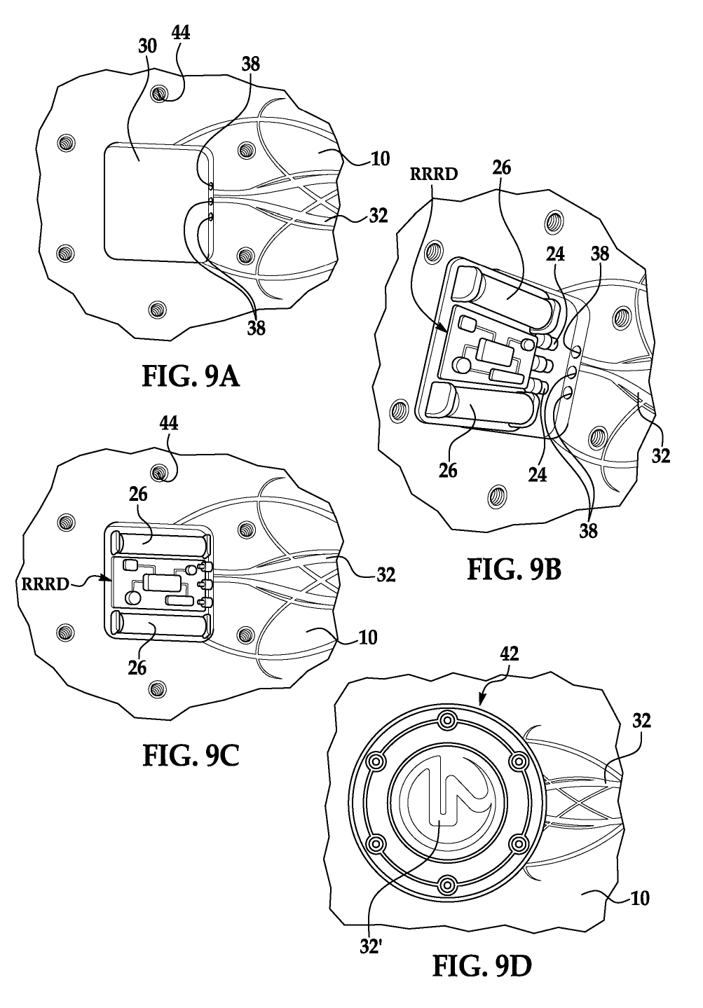

A fiber optic sheet 20 (see also FIGS. 5A and 6A) having a plurality of apertures 22, 22′ therethrough is configured to be established in the integration pocket 18 of the core layer 16. An illumination source 24 (see FIG. 9B) and a power supply 26 (see FIG. 9B) are each operatively connected to the fiber optic sheet 20, and are operatively positioned within housing 30.

FIG. 11 also illustrates tips TP1, TP2 which may be incorporated in the apparatus 10 with the core layer 16. In an embodiment, the core layer 16 is shorter than the full length of the apparatus 10, and the tips T1, T2 advantageously add to the structural integrity of the apparatus 10 at this layer 16. The tips T1, T2 may be formed of polymeric materials (which may be heat treated to substantially remove oils therefrom), aluminum, or any other suitable material that will adhere to the epoxy used to adhere the layers of the apparatus 10 together.

As shown in FIG. 11, in some embodiments, the apparatus 10 further includes a soft fiberglass mesh layer 15 between the base layer 12 and the core layer 16. A cover layer 14 (also see FIG. 8) is established between the fiber optic sheet 20 and the top layer 13. It is to be understood that such layers 14, 15 are described further hereinbelow.

During formation of the apparatus 10, an epoxy configured to optimize light transmission of the apparatus 10 and adhesion between unlike materials (e.g., the fiber optic sheet 20 and the core layer 16) is established between each material or layer. The apparatus 10 is then exposed to a predetermined pressure and a predetermined temperature for a predetermined time. The predetermined pressure generally ranges from about 8,000 pounds to about 12,000 pounds, depending, at least in part, on the size of the apparatus 10. The predetermined temperature is generally equal to or less than 180° F., and in one embodiment ranges from about 120° F. and about 160° F. The predetermined time may be any time that is sufficient to cure the epoxy and bind the layers of the apparatus 10 together. In one embodiment, the time ranges from about 15 minutes to about 60 minutes. In a non-limiting example, the apparatus 10 is exposed to about 10,000 pounds of pressure and is heated to about 140° for about 30 minutes. This lamination process fuses the various materials/layers together with the epoxy rendering a waterproof, relatively flexible apparatus 10.

The epoxy used to adhere the various material/layers of the apparatus 10 generally has relatively high shear, relatively high peel strength, relatively low viscosity, and is substantially clear when cured. A non-limiting example of such an epoxy is SCOTCH-WELD™ epoxy adhesive DP100 PLUS CLEAR, commercially available from 3M. Similar epoxies are also available from Tektorious. Any epoxy that is able to flow under pressure to assure a substantially consistent adhesion during assembly and does not substantially degrade or otherwise deleteriously affect light transmission is contemplated as being within the purview of the present disclosure, for adhering the layers/materials of the apparatus 10 together.

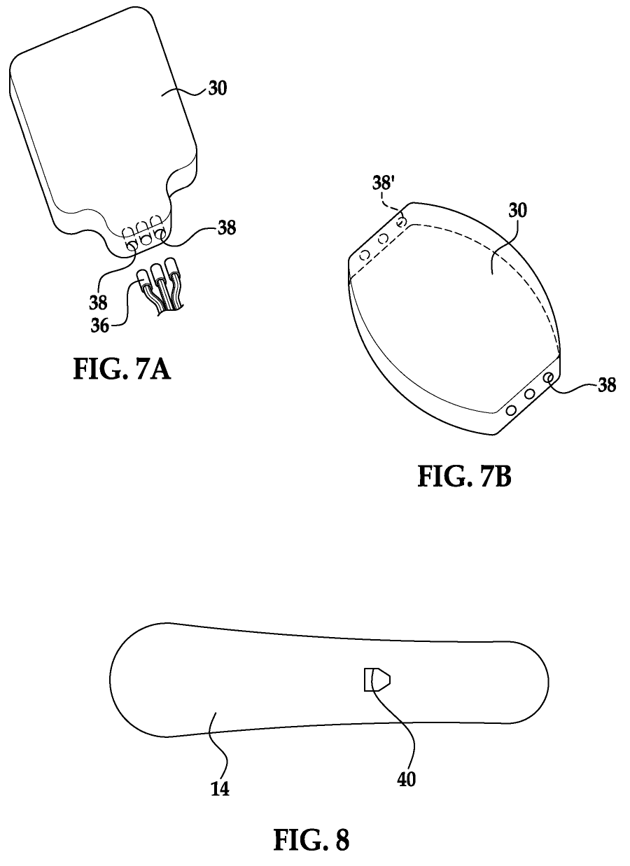

Referring now to FIGS. 1 and 2, an embodiment of the core layer 16 is depicted. The core layer 16 may be formed of wood (e.g., birch, poplar, etc.), aluminum honeycomb, carbon fibers, or other suitable materials. As shown in FIGS. 1 and 2, the core layer 16 has a fiber optic sheet assembly integration pocket 18 defined therein. This assembly integration pocket 18 includes a portion P configured to receive the fiber optic sheet 20 (shown in FIGS. 5A-6B), and a groove 28 configured to receive a housing 30 (shown in FIGS. 7A and 7B). As shown in FIGS. 1 and 2, the portion P may be defined through a portion of the thickness of the core layer 16, while the groove 28 may be defined through the entire thickness of the core layer 16. It is to be understood that in some instances, depending at least in part on the thickness of the housing 30 to be incorporated into the groove 28, the groove 28 may be defined through a portion of the thickness of the core layer 16. Generally, the portion P and groove 28 are configured such that when the fiber optic sheet 20 and the housing 30 are incorporated therein, the ferrules 36 of the fiber optic sheet 20 (shown in FIGS. 5A, 6A and 7A) align with the apertures 38 (shown in FIGS. 7A, 7B, 9A and 9B) of the housing 30.

As shown in FIG. 2, two portions P, P′ of the assembly integration pocket 18 may be formed in the core layer 16. The portions are generally formed at opposed ends of the core layer 16. In this embodiment, a single groove 28 abuts both portions P, P′ of the assembly integration pocket 18. It is to be understood that each portion P, P′ receives a separate fiber optic sheet 20. As such, this embodiment enables two fiber optic sheets 20 to be included in the apparatus 10, which in turn, enables the entire apparatus 10 to be illuminated. This embodiment also enables the fiber optic sheets 20 to operatively connect to a single housing 30 in the groove 28. This is advantageous in that one housing 30 may host the illumination source(s) 24 and power supply 26 for each of the sheets 20.

While not shown in the Figures, it is to be understood that an embodiment of the apparatus 10 including two portions P, P′ of the assembly integration pocket 18 may also include a separate groove 28 abutting each portion P, P′. As such, two housings 30 may be included in the apparatus 10. In such instances, the fiber optic sheet 20 in each portion P, P′ is operatively connected to a separate illumination source(s) 24 and power supply 26 (contained in the housing 30).

During manufacture of, and in the final apparatus 10, the fiber optic sheet 20 is positioned in the portion P, P′ of the fiber optic sheet assembly integration pocket 18. It is to be understood that the fiber optic sheet 20 includes an optical fiber support and lighting template made up of an adhesive sheet 21 having a plurality of apertures 22, 22′ defined therethrough. In one embodiment, the fiber optic sheet 20 is formed from a commercially available highly reflective fiber optic product (e.g., available from Lumitex® Inc. in Strongsville, Ohio, a non-limiting example of which is described in U.S. Pat. No. 6,874,925, incorporated herein by reference in its entirety) having a backing sheet (also referred to herein as an adhesion sheet) 21, a top laminate, and optical fibers 19 secured therebetween. In this embodiment, the top laminate is removed, and apertures 22 are perforated through the backing sheet 21. The fiber optic sheet 20 may also be formed by perforating or otherwise cutting apertures 22, 22′ in a desirable backing/adhesion sheet 21 and then adhering the fiber optics 19 thereto.

In both embodiments, the fiber optic sheet 20 may exclude a top sheet, and thus the optical fibers 19 adhered to the adhesion sheet 21 are exposed. It is to be understood, however, that a graphics sheet may be positioned over the optical fibers 19 and adhered to the adhesion sheet 21. In such an embodiment, the graphics 32 are included sub-surface as opposed to, or in addition to, on the top layer 13.

It is to be understood that the apertures 22, 22′ may be randomly or uniformly formed in the adhesion/backing sheet 21. In one embodiment, a laser is used to perforate the adhesion/backing sheet 21. The laser is generally selective and penetrates the sheet 21 sufficiently to form the apertures 22, 22′ without melting or otherwise deleteriously affecting the adhesion sheet 21. The apertures 22, 22′ may be circular or square holes or other regular or non-regular geometric cut-outs. These apertures 22, 22′ create spot welds that allow the previously described epoxy resin to flow therethrough. Additionally, the apertures 22, 22′ may be a template for enhancing or attenuating lighting effects (e.g., optical fibers 19 extending over apertures 22, 22′ are not as bright as those extending over the adhesion sheet 21, in part because of the reflectivity of the adhesion sheet 21).

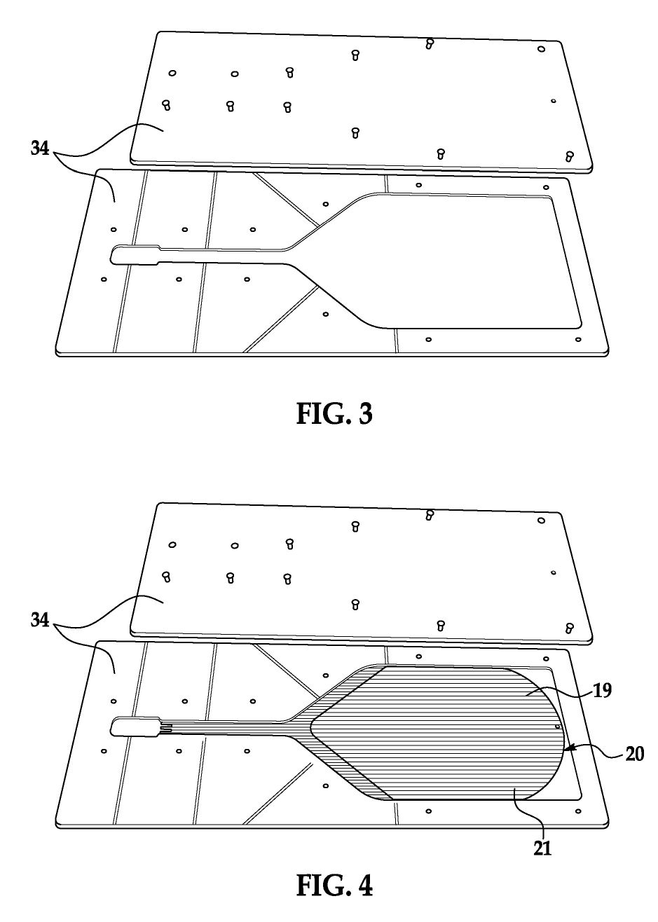

In some instances, the fiber optic sheet 20 is encased in an epoxy prior to laminating the layers/materials to form the apparatus 19. This epoxy may be the same as the epoxy used for apparatus lamination, or it may be different than and compatible with the epoxy used for apparatus lamination. During lamination, the two epoxies intermingle to increase adhesion. The addition of the epoxy casing to the fiber optic sheet 20 generally increases the strength of the connection between the fiber optics 19 and the surrounding layers 14, 16. Furthermore, the epoxy casing may advantageously assist in keeping the fibers 19 secure and the fiber optic sheet 20 from shifting out of the portion P, P′ during lamination. FIGS. 3 and 4 depict an embodiment of tooling 34, which operates as a press to create the epoxy encased fiber optic sheet 20.

In other instances, the fiber optic sheet 20 is not encased in epoxy prior to apparatus lamination. In this embodiment, the adhesion sheet 21 having exposed optical fibers 19 adhered thereto and bundled via ferrules 36 (described further hereinbelow) is positioned in the portion P, P′, and the epoxy used to laminate the layers/materials of the apparatus flows through the apertures 22, 22′. Because the fiber optic sheet 20 is not encased in epoxy prior to lamination in some embodiments, it may be desirable to include pins or other means to secure the fiber optic sheet 20 to the portion P, P′ during lamination.

FIGS. 5A and 6A illustrate two different embodiments of the fiber optic sheet 20. In both embodiments, one or more layers of individual optical fibers 19 are arranged in close proximity to each other. Each optical fiber 19 has a light transmitting core of an optically transparent material and an outer sheath of a second optically transparent material. The outer sheath material generally has a relatively lower index of refraction than the core material, at least in part to prevent the escape of light along its length. Non-limiting examples of the core material include glass or plastic or a multi-strand filament having the desired optical characteristics. As previously mentioned, the outer sheath material is also optically transparent, but because the index of refraction of the sheath material is less than that of the core material, substantially total internal reflection is obtained at the sheath-core interface, as is well known in the art.

Generally, all of the optical fibers 19 are adhered at one or more points along their length to the adhesion sheet 21. The adhesion sheet 21 is generally formed of a polyester film (e.g., MYLAR®, commercially available from Dupont) or some other suitable light reflective material. Such a material reflects any light directed toward the sheet 21 and back, for example, toward the top surface S2, to provide background illumination. The adhesion sheet 21 also includes any desirable adhesive on one side to adhere the optical fibers 19 thereto. The adhesion sheet 21 may have any desirable shape, depending at least in part, on the shape of the core layer 16, the shape of the portion of the recreational apparatus 10 to be lit via the fiber optic sheet 20, and/or the desirable lighting effects.

As shown in FIGS. 5A and 6A, the adhesion sheet 21 includes one end E1 that extends to the end of the fiber optic sheet 20, and another end E2 that is either cut short of where the fibers 19 taper to be bundled (see FIG. 5A) or extends into the area where the fibers 19 are tapered (see FIG. 6A). The adhesion sheet 21 may have a square or rectangular shape (see FIG. 5A), or the end E1 of the sheet 21 may be cut to substantially the same shape as the other layers of the apparatus 10 (see FIG. 6A). In an embodiment, the end E1 of the sheet 21 (and thus the end of the fiber optic sheet 20) may be cut back such that when positioned in the portion P, P′ it sits back from about 15 mm to about 30 mm from an end of the apparatus 10. It is believed that the cut back adhesion and fiber optic sheets 21, 20 interact with the epoxy at the end of the apparatus to enhance the lighting, provide a strong bond, and compliment the graphics 32 (see, e.g., FIG. 13B) at the end of the apparatus 10.

In some instances (e.g., when the apertures 22, 22′ are formed prior to fiber 19 adhesion), the optical fibers 19 extend over the apertures 22, 22′, thereby enabling light transmission from the light source 24 (not shown in FIGS. 5A and 6A) to the opposed end of each optical fiber 19. In other instances, the optical fibers 19 may be terminated or disrupted at one or more apertures 22, 22′. This generally results when such apertures 22, 22′ are formed after fiber 19 adhesion to the sheet 21. It is believed that any damage to the optical fibers 19 is compensated for by internal reflectivity due, at least in part, to the number of non-damaged optical fiber 19 strands and the reflective adhesion sheet 21. As such, it is believed that the lighting of the fiber optic sheet 20 and apparatus 20 in these other instances is not deleteriously affected.

The optical fibers 19 may extend beyond one end E2 of the adhesion sheet 21. As shown in FIGS. 5A and 6A, the optical fibers 19 extend beyond end E2, and are terminated at end E1. Generally, the fibers 19 that extend beyond the end E2 are bundled together to form one or more light cables/bundles 23 for transmitting light from one or more light/illumination sources 24 (not shown in FIGS. 5A or 6A) to the optical fibers 19.

In some embodiments, the fibers 19 are bundled by the epoxy (described hereinabove) that encases the entire sheet 20 (formed prior to final apparatus lamination). In other embodiments, the fibers 19 are adhered to the adhesion sheet 21, but are otherwise not adhered or encased until final apparatus lamination.

FIGS. 5B and 6B are cross-sectional views taken along line 5B-5B and line 6B-6B of FIGS. 5A and 6A, respectively. As shown in both FIGS. 5B and 6B, the apertures 22 or 22 and 22′ extend through the adhesion sheet 21, and the optical fibers 19 are positioned over the sheet 21 and over at least some of the apertures 22, or 22 and 22′. Since the apertures 22′ are cut-outs, they are, in some instances, larger than the apertures 22, as shown in FIG. 6B.

One or more ferrule type connectors 36, which may serve as an interface between the light source 24 and the optical fiber 19 ends, may be crimped onto the outermost end of the light cable 23. As shown in FIGS. 5A and 6A, one end of the respective groups of fibers 19 are inserted into respective ferrules 36.

Both FIGS. 5A and 6A show light cable/bundle 23 extending a considerable distance beyond the adhesion sheet 21. It is to be understood that the length of the cable 23 depends, at least in part on the distance from the groove 28 configured to hold the housing 30, to an end of the core layer 16, or the desirable distance from the groove 28 to an end E1 of the fiber optic sheet 30. As such, the light cable 23 may be made much shorter and more compact than the examples shown in the figures. This may be accomplished by pulling the optical fiber ends through the ferrule(s) 36 prior to crimping and heat forming the fibers 19 while holding the optical fibers 19 and ferrule(s) 36 at a desired position and orientation adjacent the end E2 of the adhesion sheet 21 so the optical fibers 19 and ferrule(s) 36 retain their shape and orientation adjacent sheet 21. Heat forming controls the minimum radius of the optical fibers 19 and relieves stresses in such fibers 19 to minimize the escape of light from the light cable 23.

In some embodiments, the fiber optic sheet 20 also has a fiberglass mesh incorporated therewith. In still other embodiments, the epoxy encasing the fiber optic sheet 20 includes fiberglass. Fiberglass is believed to increase the strength of the fiber optic sheet 20.

Referring now to FIGS. 7A and 7B, two embodiments of the housing 30 are depicted. The housing 30 (which is ultimately established in the groove 28 of the core layer 16) is generally formed of plastic and is designed to accept the ferrules 36 of the fiber optic sheet 20. Apertures 38, 38′ configured to receive each ferrule 36 are formed in both embodiments of the housing 30. Furthermore, each embodiment of the housing 30 is configured to protect the ferrule(s) 36 from the epoxy resin and the conditions (e.g., high temperature and pressure) of the laminating process. The embodiment shown in FIG. 7A includes one set of apertures 38, and is generally designed for an embodiment of the apparatus 10 in which lighting is desirable on one end. The embodiment shown in FIG. 7B includes two sets of apertures 38, 38′, and is generally designed for an embodiment of the apparatus 10 in which lighting is desirable on opposed ends. It is to be understood that either of the embodiments may be configured for receiving ferrules 36 from one fiber optic sheet 20 or from two or more fiber optic sheets 20. For example, the embodiment shown in FIG. 7A may include a second set of apertures 38′ at an opposed end of the housing 30, or the embodiment shown in FIG. 7B may exclude the second set of apertures 38′. Furthermore, it may be desirable, depending on the apparatus 10, to have the housing apertures 38, 38′ positioned approximately 900 from each other, or on each side of the housing 30. Still further, it is to be understood that when multiple sets of apertures 38, 38′ are included, the same or a different number of apertures 38, 38′ may be utilized, depending, at least in part, on the number of ferrules 36 of the corresponding fiber optic sheets 20.

It is to be understood that the shapes of the housings 30 (and corresponding grooves 28) shown herein are examples, and that each may be formed to have any suitable or desirable shape.

The housing 30 is generally hollow inside, such that it is capable of housing the illumination source(s) 24, the power supply 26, other desirable electronics (e.g., preset driver or RRRD, both of which are described further hereinbelow), and the one or more ferrules 36 of the fiber optic sheet 20.

Prior to lamination, the housing 30 may be fit into the groove 28 such that the apertures 38 of the housing 30 protectively engage the ferrules 36.

Referring now to FIG. 8, the cover layer 14 of the apparatus 10 is depicted. In an embodiment, the cover layer 14 is a stiff fiberglass mesh layer. The fiberglass mesh cover layer 14 has a directional cross grain which may be designed differently, depending, at least in part, on the desired softness or stiffness of the apparatus 10. It is believed that such fiberglass mesh layers advantageously contribute to the structural integrity of the apparatus 10, without deleteriously affecting light transmission and flexibility.

As shown in FIG. 8, a portion 40 of the cover layer 14 may be routed out, such that the housing 30 is accessible. The portion 40 may be the shape of the housing 30, or another shape that enables access to the housing 30. It is to be understood that the cover layer 14 may be routed out prior to lamination, or after lamination (discussed further hereinbelow). Furthermore, in embodiments in which the illumination supply 24 and power supply 26 are established in the housing 30 prior to lamination, such a routed out portion 40 may not be desirable.

It is to be understood that generally the cover layer 14 is relatively thin, such that any graphics 32 established on the top layer 13 (or sub-surface) may be illuminated via the fiber optic sheet 20.

As previously stated, the epoxy is established between each of the materials/layers of the apparatus 10. Once the materials/layers and the epoxy of the apparatus 10 are in place, the high pressure lamination process is used to seal the materials/layers of the apparatus 10. As previously mentioned, when the fiber optic sheet 20 is encased in epoxy, the encasing epoxy and the epoxy used during the lamination process are compatible and enhance adhesion of the multiple layers.

After lamination, a portion of the top layer 13 and a top of the housing 30 may be routed out to expose the apertures 38, the ferrules 36 (located in the housing 30), and the inside of the housing 30 (see FIG. 9A). Generally, the routed out portion of the top layer 13 is adjacent the portion 40 of the cover layer 14. In embodiments in which the portion 40 of the cover layer 14 is not routed prior to lamination, it is to be understood that such routing may take place when the top layer 13 and the top of the housing 30 are routed out.

FIGS. 9A through 9D illustrate 1) the housing 30 after the top layer 13, the cover layer 14 and the housing top have been routed out (FIG. 9A), 2) the insertion of the power and illumination supplies 24, 26 into the housing 30 (FIG. 9B), 3) the power and illumination supplies 24, 26 operatively positioned in the housing 30 (FIG. 9C), and 4) a stomp pad 42 removably secured to the top layer 13 via attaching means 44 (FIG. 9D).

As shown in FIGS. 9B and 9C, the illumination source 24 (e.g., a light emitting diode) and the power supply 26 (e.g., batteries and electronic circuitry) may be snapped or placed into the routed out housing 30. In some embodiments, the illumination source 24 and power supply 26 may be smaller than the routed out portion of the housing 30 such that additional space exists for maneuvering the source 24 and supply 26 into place.

The power supply 26 may be conformal coated to render it waterproof. The power supply 26 is generally designed to light the illumination source 24, which illuminates the optical fibers 19 of sheet 20. The power supply may be any type of battery, including, for example, alkaline batteries, lithium ion batteries, nickel ion batteries, or other rechargeable batteries. It is to be understood that the electronics incorporated into the housing 30 any rechargeable battery. An integrated power pump may also be included for enhanced battery life. In an embodiment in which the apparatus 10 is a skateboard, power from the wheels may be integrated with the power supply 26 in the housing 30.

As shown in the example embodiment of FIGS. 9B and 9C, each illumination source 24 is a light emitting diode (LED) that operatively and electrically connects to one of the ferrules 36 (and corresponding optical fibers 19) located in apertures 38. In this embodiment, the light sources 24 are positioned such that the light is directed and travels in one direction. It is to be understood however, that the illumination/light sources 24 may be positioned such that light travels in multiple directions (e.g., such sources 24 would be used in conjunction with the housing 30 of FIG. 7B). While not shown in the figures, it is to be understood that one or more illumination sources 24 may also be positioned such that light is directed toward the surface S2 of the apparatus 10, but such sources 24 do not operatively connect to any optical fibers 19.

The illumination/light source 24 may also be, for example, incandescent, halogen, xenon, metal-halide, organic light emitting diodes (OLED), polymer light emitting diodes (PLED), and fluorescent.

As shown in FIG. 9D, a stomp pad 42 may be secured (e.g., via means 44) to the top layer 13 to protect the illumination source 24, the power supply 26, and the ferrules 36 during use of the apparatus 10. It is believed that the stomp pad 42 advantageously protects the illumination source 24 etc. from wear and tear, and from water, moisture, etc. The stomp pad 42 may include a groove that houses an o-ring or gasket, and/or may include any other desired sealing member(s). Generally, the stomp pad 42 is a round (as shown in FIG. 9D) or an oval shaped single piece configured to cover the routed out portions and the elements in the housing 30. It is believed that the oval/elliptical configuration may be advantageous in that the corresponding, complementarily shaped stomp pad-receiving groove, e.g., in cover layer 14, affects the overall apparatus 10 properties such that enhanced strength results. For example, an elliptical groove in cover layer 14 to accept stomp pad 42 may advantageously provide less stress to the apparatus 10 as it flexes and may improve the structural integrity of the apparatus 10. It is to be understood that the stomp pad 42 may be removable such that one can access the power supply 26, the illumination source(s) 24, and any other electronics stored in the housing 30.

The stomp pad 42 may also include graphical indicia 32′ printed, embedded, partially embedded, or otherwise established on/in the surface of the stomp pad 42.

In another embodiment, the power supply 26, the illumination source(s) 24, and any other electronics may be enclosed in the housing 30 prior to the lamination process. This forms a housing 30 having the electronics already disposed therein. It is to be understood that the housing 30 is placed within the groove 28, and the illumination source 24, the power supply 26, and any other electronics are operatively connected to the ferrules 36 prior to the high temperature lamination process. This embodiment eliminates the need for post routing, as the electronics are inserted prior to final apparatus 10 processing. Generally, this embodiment uses a capacitor coupling connection to deliver power to the embedded power supply 26, as it is located within the apparatus 10. Furthermore, no routed out or other access panel is created.

Referring now to FIG. 10, one embodiment of the apparatus 10 is depicted. As shown, the stomp pad 42 is secured to the top layer 13. In this embodiment, graphics 32 are printed on the top layer 13. It is to be understood that the base layer 12 and/or top layer 13 may have graphics 32 established thereon. The graphics 32 may have any random and/or uniform design, and may include alphanumeric indicia, regular and/or non-regular geometric shapes, or any other desirable configuration. Furthermore, the graphics 32 may be located at one end of the apparatus 10, or at both ends of the apparatus 10. Generally, the power supply 26, the illumination source(s) 24, and the fiber optic sheet(s) 20 will be configured to illuminate any desirable graphics 32.

In any of the embodiments disclosed herein, the power supply 26, illumination source(s) 24, and other electronics (e.g., preset driver, RRRD described hereinbelow) implemented within the apparatus 10 may be turned on and off via any suitable means. Non-limiting examples of such means include a magnetic reed switch, a remote control, or the like.

Embodiments of the apparatus 10 may also include metal edges and/or side runners (neither of which are shown). Metal edges are generally used to form an edge of the apparatus 10, which may be particularly useful for a snowboard (i.e., to carve in the snow). Such metal edges may be positioned around the entire perimeter of the apparatus 10, along just the sides of the apparatus 10, and/or along the surface S1. As a non-limiting example, the metal edges are formed of stainless steel. Side runners are generally used to seal the side of the apparatus 10 and to dampen the metal edges. The side runners may be different colors and materials, depending on the softness or stiffness desired in the apparatus 10.

Electronics (as shown in FIGS. 9B and 9C), such as a preset driver or a recreational run recording device RRRD, may be operatively connected to the power supply 26 and illumination source(s) 24 to control at least illumination. It is to be understood that the illumination may be solid, flashing, blinking or combinations thereof. The flash rate and lighting sequence may be controlled via preset lighting patterns or integrated auto-motion light driving. The preset lighting patterns are programmed into the driver (generally prior to operatively connecting it to power supply 26), and are user-selected through a cycling reed switch. The auto-motion light driving is accomplished via an integrated accelerometer (discussed further hereinbelow) that tracks the movement of the apparatus 10, and chooses lighting patterns that are programmable and customizable by the user.

Any embodiment of the apparatus 10 disclosed herein may include the preset driver or the recreational run recording device RRRD (shown in FIGS. 9B and 9C). Such a driver or device RRRD may be housed in the housing 30, or may be in operative communication with the power supply 26 and illumination source 22 via a wireless connection. In the latter embodiment, the driver or RRRD may be worn by a user. In this embodiment, the electronics are stored within a portable housing that is relatively small and lightweight.

It is to be understood that the driver or recreational run recording device RRRD disclosed herein may also be used with recreational devices other than the snowboard shown in FIGS. 10 and 11, including bikes, race cars, skis, etc.

An embodiment of the RRRD is an accelerometer “G” force microprocessor controlled system that is capable of recording, from time T1 to time T2, x, y, z event activity. An inertia acceleration sensor and an x, y, z position sensor interface with a microprocessor via a serial bus. It is to be understood that the RRRD is capable of reading and recording time/position variations and speed calculations of the apparatus 10 (or other recreational device) during a run.

The data collected by the RRRD may be stored in and/or transmitted (in real-time) to the recreational apparatus 10 and/or to another device (e.g., PCs, cell phones, displays, or other like electronic devices). Real-time transmission of the data may be accomplished via short range wireless communication (e.g., BLUETOOTH®), WiFi/WiMax, or radio frequencies. The data may be transmitted as it is received, in packets, or as a bulk transmission.

The collected data may be used in a number of ways. A user may download or transmit the data for analysis (e.g., discuss the run with a coach to improve performance); for implementation into digital media (e.g., data is used to create a personalized video game); or for enhancing broadcasting (e.g., data is transmitted to and used by a broadcaster as a recreational run (e.g., snowboarding run, bike or car laps, etc.) occurs.

The RRRD may also be operatively connected to the illumination source 24, such that when the RRRD recognizes a particular x, y, z, position, the illumination source 24 lights the fiber optic sheet 20 and graphics 32 in a predetermined manner. The predetermined manner may be programmed by a user, for example, using a PC or other electronic device in operative communication with the RRRD. This may be particularly useful for broadcasting a sporting event. For example, an announcer may be aware that certain jumps/positions are associated with certain lighting schemes of the apparatus 10. As such, when the apparatus 10 lights up in the predetermined manner, the announcer knows that the associated jump was performed.

The RRRD may also be operatively connected to other electronic devices (e.g., an iPOD®) such that when the RRRD recognizes a particular x, y, z position, the other electronic device performs some predetermined function. For example, if a particular jump is recognized by the RRRD, the iPOD® will play a song that the user has previously associated with that jump.

The RRRD may be activated via a number of different methods. Examples include magnetic reed switches, fobs, or a remote recording media device. The RRRD may be run on disposable or rechargeable batteries. Two forms of rechargeable batteries include 1) solar panels located on the exterior of the apparatus 10 in which the RRRD is incorporated (e.g., implanted within the graphics of the apparatus 10, discussed hereinabove), or 2) a transponder with a wireless hook up that receives charge and transmits it to the battery of the RRRD.

Embodiments of the apparatus 10 and/or RRRD disclosed herein may also include an RFID that is capable of alerting an owner when the apparatus 10 and/or RRRD has been moved beyond a predetermined distance (e.g., if someone else has moved the board).

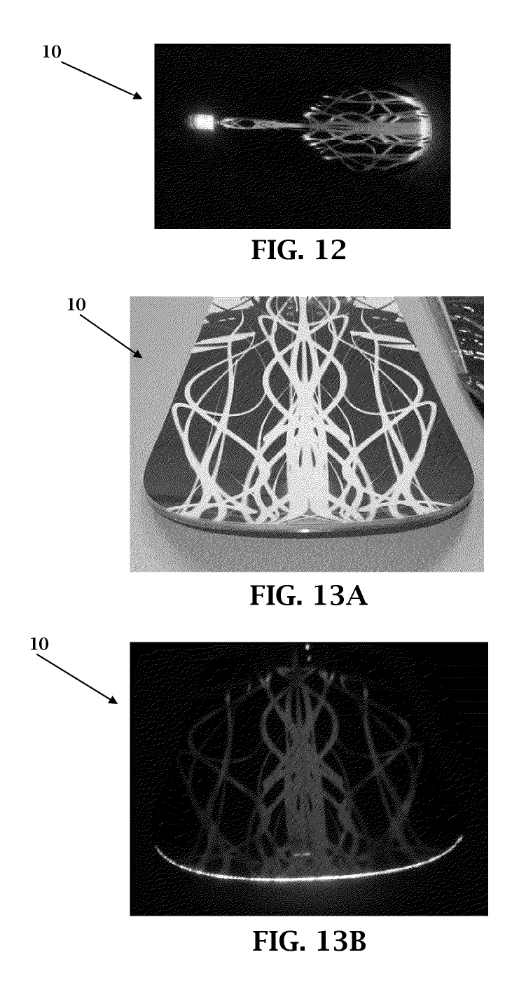

Photographs of an embodiment of the apparatus 10 are shown in FIGS. 12, 13A and 13B. In FIG. 12, the apparatus is lit up, and the stomp pad 42 is removed (or is formed of a translucent or transparent material) to illustrate the lighting within the housing 30. FIGS. 13A and 13B illustrate another embodiment of the apparatus 10 prior to illumination and after illumination, respectively. This embodiment includes the cut-back adhesion sheet 21 in the fiber optic sheet 20, and this is believed to enhance the glow at an edge of the apparatus 10, as shown in FIG. 13B. The colors of the graphics 32 may be changed by changing the illumination source 24 and/or changing the color of the graphics 32 on the top layer 13 (or sub-surface).

While several embodiments have been described in detail, it will be apparent to those skilled in the art that the disclosed embodiments may be modified. Therefore, the foregoing description is to be considered exemplary rather than limiting.

What is claimed is:

1. A recreational apparatus, comprising:
a base layer forming one opposed side of the apparatus;
a core layer established on the base layer, the core layer having a fiber optic sheet assembly integration pocket defined therein;
a fiber optic sheet established in the integration pocket, the fiber optic sheet having a plurality of apertures therethrough;
an illumination source and a power supply operatively connected to the fiber optic sheet; and
a cover layer established on the fiber optic sheet and the core layer.

2. The recreational apparatus as defined in claim 1, further comprising an epoxy securing the apparatus together, wherein the epoxy is configured to adhere two different materials and to flow through the plurality of apertures in the fiber optic sheet.

3. The recreational apparatus as defined in claim 1, further comprising a top layer secured to the cover layer and forming an other opposed side of the apparatus, wherein at least one of the base layer or the top layer has graphics established thereon, and wherein the graphics are illuminated via the illumination source and the fiber optic sheet.

4. The recreational apparatus as defined in claim 1 wherein the fiber optic sheet assembly integration pocket includes a groove configured to receive a housing having at least one aperture that receives at least one ferrule of the fiber optic sheet.

5. The recreational apparatus as defined in claim 4 wherein the housing is accessible via a stomp pad removably secured to a top layer established on the cover layer.

6. The recreational apparatus as defined in claim 4 wherein the illumination source and the power supply are housed in the housing.

7. The recreational apparatus as defined in claim 1, further comprising at least one of a recreational run recording device or a preset driver in operative communication with the power supply and the illumination source.

8. The recreational apparatus as defined in claim 7 wherein the apparatus includes the recreational run recording device and wherein the apparatus further comprises means for real-time communication of recorded recreational run parameters.

9. The recreational apparatus as defined in claim 7 wherein the apparatus includes the recreational run recording device, which includes:
an accelerometer G-force microprocessor;
an inertia sensor operatively connected to the microprocessor; and
a position sensor operatively connected to the microprocessor, thereby enabling speed calculation and time/position variation.

10. The recreational apparatus as defined in claim 1 wherein the apparatus is selected from snowboards, skateboards, snowskis, waterskis, wakeboards, street luges, motorcycles, snowmobiles, mountain bikes, and motorcross bikes.

11. The recreational apparatus as defined in claim 1, further comprising an RFID operatively connected to the power supply.

12. The recreational apparatus as defined in claim 1 wherein the fiber optic sheet is reinforced with fiberglass.

13. The recreational apparatus as defined in claim 1 wherein the core layer further comprises a second fiber optic sheet assembly integration pocket defined therein, and wherein the recreational apparatus further comprises a second fiber optic sheet established in the second integration pocket, the second fiber optic sheet having a plurality of apertures therethrough.

14. The recreational apparatus as defined in claim 1, further comprising:
a soft fiberglass mesh layer established between the base layer and the core layer; and
a top layer established on the cover layer.

15. A method of making a recreational apparatus, comprising:
establishing a fiber optic sheet assembly into a core layer having a fiber optic sheet assembly integration pocket, the fiber optic sheet assembly having:
an adhesion sheet with a plurality of apertures extending therethrough;
optical fibers adhered to at least a portion of the adhesion sheet; and
at least one ferrule binding ends of the optical fibers;
securing the at least one ferrule in a housing established in a groove defined in the core layer; and
laminating the core layer to a cover layer via an epoxy configured to adhere the core and cover layers, wherein the epoxy flows through the plurality of apertures of the fiber optic sheet.

16. The method as defined in claim 15, further comprising:
laminating a top layer to the cover layer; and
routing out a portion of the top layer, the cover layer and a portion of the housing to expose an interior of the housing and the at least one ferrule.

17. The method as defined in claim 16, further comprising establishing a power supply and an illumination source in the housing such that each is operatively connected to the at least one ferrule.

18. The method as defined in claim 16, further comprising removably securing a stomp pad on the top layer to cover the routed out portions.

19. The method as defined in claim 15 wherein securing the at least one ferrule in the housing includes operatively connecting the at least one ferrule to a power supply and an illumination source in the housing.

20. A method of making a fiber optic sheet, comprising:
cutting an adhesive sheet in a predetermined manner to form an optical fiber support and lighting template having a plurality of apertures therethrough; and
adhering fiber optics to the optical fiber support and lighting template.

21. A method of making a fiber optic sheet, comprising:
providing a plurality of optical fibers secured between two opposed sheets;
removing one of the two opposed sheets such that the plurality of optical fibers remain adhered to an other of the two opposed sheets; and
cutting the other of the two opposed sheets in a predetermined manner to form a plurality of apertures therethrough.

22. A fiber optic sheet, comprising:
an optical fiber support and lighting template including an adhesive sheet and a plurality of apertures defined through the adhesive sheet; and
a plurality of optical fibers, at least some of which are adhered to the adhesive sheet.

23. The fiber optic sheet as defined in claim 22 wherein the adhesive sheet has two opposed ends, wherein one of the two opposed ends has a shape that corresponds with a shape of a recreational apparatus configured to receive the fiber optic sheet, and wherein an other of the two opposed ends is tapered.

24. The fiber optic sheet as defined in claim 22 wherein the plurality of apertures include circular apertures, square apertures, cut-outs, or combinations thereof.

25. The fiber optic sheet as defined in claim 22 wherein at least a portion of each of the plurality of optical fibers are not adhered to the adhesive sheet and are encased in an epoxy.

26. The fiber optic sheet as defined in claim 22 wherein each of the plurality of optical fibers has an end that is not adhered to the adhesive sheet, and wherein each of the non-adhered ends is operatively positioned in one of a plurality of ferrules.
